(19) United States
(12) Patent Application Publication
(10) Pub. No.: US 2021/0192353 A1
(43) Pub. Date: Jun. 24, 2021

(54) PROCESSING UNIT, PROCESSOR CORE, NEURAL NETWORK TRAINING MACHINE, AND METHOD

(71) Applicant: ALIBABA GROUP HOLDING LIMITED, George Town (KY)

(72) Inventors: Tianchan GUAN, Shanghai (CN); Yuan GAO, Shanghai (CN); Chunsheng LIU, Shanghai (CN); Jiaoyan CHEN, Shanghai (CN)

(21) Appl. No.: 17/129,148

(22) Filed: Dec. 21, 2020

(30) Foreign Application Priority Data
Dec. 20, 2019 (CN) 201911330492.X

(51) Int. Cl. G06N 3/08; G06N 3/063; G06F 9/30

(52) U.S. Cl. CPC G06N 3/082; G06F 9/30036; G06N 3/063

(57) ABSTRACT

Embodiments of the present disclosure provide a processing unit, a processor core, a neural network training machine and a method for processing. The method can include: acquiring a compressed weight signal; and decompressing the compressed weight signal into a weight signal and a trimming signal, wherein the weight signal comprises a weight of each neural network node, the trimming signal indicates whether the weight of each neural network node is used in a weight gradient computation, the trimming signal is used for controlling an access to an operand memory storing operands used in the weight computation of one or more neural network nodes corresponding to the operand memory, and the trimming signal is further used for controlling a computing unit to perform weight gradient computation using the weight signal and the operands for the one or more neural network nodes.

### CROSS-REFERENCE TO RELATED APPLICATION

The present disclosure claims the benefits of priority to Chinese Patent Application No. 201911330492.X filed on Dec. 20, 2019, which is incorporated herein by reference in its entirety.

### BACKGROUND

A neural network generally refers to an artificial neural network (ANN), which is a mathematical model of an algorithm imitating neural network behavior characteristics of humans for distributed parallel information processing. The neural network processes information by adjusting the interconnection relationship between a large number of internal nodes. The ANN is a nonlinear adaptive information processing system including a large number of interconnected processing units, each of which is referred to as a neural network node. Each neural network node receives an input, processes the input, and generates an output. This output is sent to other neural network nodes for further processing or is outputted as a final result. When entering a neural network node, an input can be multiplied by a weight. For example, if a neuron has two inputs, each of the inputs can have an associated weight assigned thereto. The weights are randomly initialized and updated during model training. A weight of zero means that a specific feature is insignificant. Assuming that an input is “a” and a weight associated therewith is W1, then after going through a neural network node, an output becomes a times W1. In a process of training the neural network, the weights of the neural network nodes are solved and updated. The weights are solved by determining a weight gradient that is a gradient of the weights of the neural network nodes. and using a gradient descent method based on the weight gradient and other operands. Computation of the weight gradient occupies a very large part of computation and storage resources of the entire neural network. If the weight gradient of each neural network is solved, a large amount of resources can be occupied. Therefore, trimming can be conducted in an early stage of training such that some neural network nodes that have little effect on the computing result are not included in the training when the weight gradient is computed. By trimming in the early stage of training, most weights can be excluded from consideration since the early stage of neural network training. That is, the computation of a weight gradient of most neural network nodes can be omitted without affecting the precision too much, thereby reducing power consumption of the neural network training and accelerating the neural network training.

Existing early trimming algorithms are generally implemented by software. During software implementation, a gradient of trimmed weights is still computed, which actually does not save the computation overhead and the memory access overhead of the neural network training. Therefore, these conventional implementations are inefficient.

### SUMMARY

Embodiments of the present disclosure provide a processing unit, a processor core, a neural network training machine and a method for processing. The method can include: acquiring a compressed weight signal; and decompressing the compressed weight signal into a weight signal and a trimming signal, wherein the weight signal comprises a weight of each neural network node, the trimming signal indicates whether the weight of each neural network node is used in a weight gradient computation, the trimming signal is used for controlling an access to an operand memory storing operands used in the weight computation of one or more neural network nodes corresponding to the operand memory, and the trimming signal is further used for controlling a computing unit to perform weight gradient computation using the weight signal and the operands for the one or more neural network nodes.

### BRIEF DESCRIPTION OF THE DRAWINGS

The accompanying drawings described herein are used to provide further understanding of the present disclosure and constitute a part of the present disclosure. Exemplary embodiments of the present disclosure and descriptions of the exemplary embodiments are used to explain the present disclosure and are not intended to constitute inappropriate limitations to the present disclosure. In the accompanying drawings:

FIG. 1 illustrates a system architecture diagram of an exemplary neural network training and use environment, consistent with some embodiments of the present disclosure.

FIG. 2 is a block diagram of an exemplary neural network training machine, consistent with some embodiments of the present disclosure.

FIG. 3 is a block diagram of an exemplary neural network training machine, consistent with some embodiments of the present disclosure.

FIG. 4 is a schematic block diagram of an exemplary memory in a neural network training machine, consistent with some embodiments of the present disclosure.

FIG. 5 is a schematic block diagram of an exemplary processing unit in a neural network training machine, consistent with some embodiments of the present disclosure.

FIG. 6 is a schematic block diagram of an exemplary processing unit in a neural network training machine, consistent with some embodiments of the present disclosure.

FIG. 7 is a schematic block diagram of an exemplary processing unit in a neural network training machine, consistent with some embodiments of the present disclosure.

FIG. 8 is a schematic block diagram of an exemplary processing unit in a neural network training machine, consistent with some embodiments of the present disclosure.

FIG. 9 is a schematic diagram of an exemplary control mode of controlling a computing unit by a computation enabling unit, consistent with some embodiments of the present disclosure.

FIG. 10 is a schematic diagram of an exemplary control mode of controlling a computing unit by a computation enabling unit, consistent with some embodiments of the present disclosure.

FIG. 11 is a schematic diagram of an exemplary control mode of controlling an operand memory by a first storage control unit, consistent with some embodiments of the present disclosure.

FIG. 12 is a schematic diagram of an exemplary control mode of controlling an operand memory by a first storage control unit, consistent with some embodiments of the present disclosure.

FIG. 13 is a schematic diagram of an exemplary weight signal and an exemplary corresponding trimming signal, consistent with some embodiments of the present disclosure.

FIG. 14 is a flowchart of an exemplary processing method, consistent with some embodiments of the present disclosure.

### DETAILED DESCRIPTION

To facilitate understanding of the solutions in the present disclosure, the technical solutions in some of the embodiments of the present disclosure will be described with reference to the accompanying drawings. It is appreciated that the described embodiments are merely a part of rather than all the embodiments of the present disclosure. Consistent with the present disclosure, other embodiments can be obtained without departing from the principles disclosed herein. Such embodiments shall also fall within the protection scope of the present disclosure.

Embodiments of the present disclosure provide technical solutions to reduce a computation overhead of a processor and an access overhead of a memory when determining a weight gradient of a neural network.

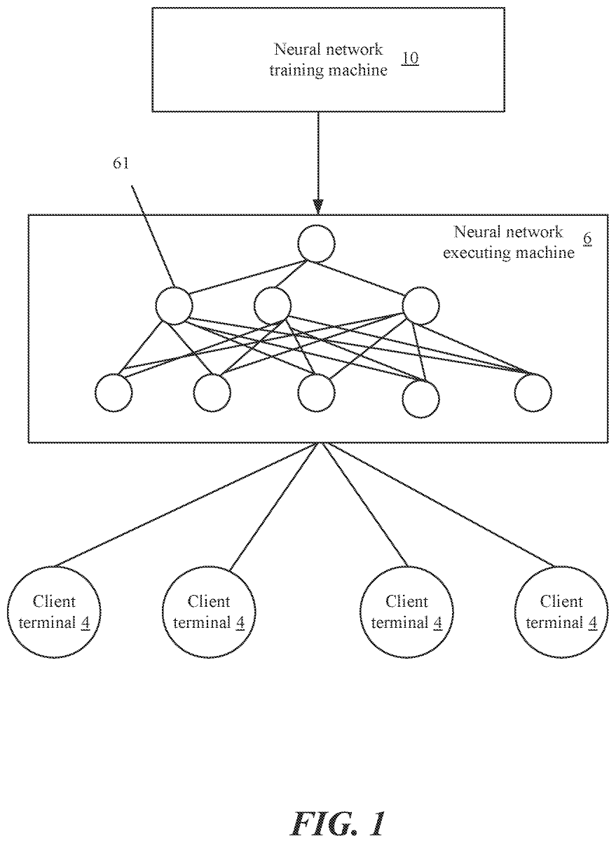

FIG. 1 illustrates a system architecture diagram of an exemplary neural network training and use environment, consistent with some embodiments of the present disclosure. The system architecture shown in FIG. 1 includes client terminal 4, neural network executing machine 6, and neural network training machine 10. Neural network executing machine 6 and neural network training machine 10 are on the side of a data center.

The data center is a device network that is globally coordinated to transmit, accelerate, display, compute, and store data information on network infrastructure of the Internet. In future development, data centers can also become assets of enterprises in competition. With the widespread application of data centers, artificial intelligence is increasingly applied to data centers. As an important technology of artificial intelligence, neural networks have been widely used in big data analysis and operation of data centers. When training these neural networks, it is necessary to repeatedly solve and update weights of neural network nodes. When solving the weights, it is necessary to first determine a weight gradient. Computation of weight gradients occupies a large part of computation and storage resources of an entire neural network. The computation of the weight gradients has also become a significant bottleneck for current data centers to reduce the resource consumption and improve the processing speed.

Client terminal 4 is an entity requiring information processing, which inputs data required by information processing to neural network executing machine 6 and receives an information processing result outputted from neural network executing machine 6. Client terminal 4 that inputs data to neural network executing machine 6 and client terminal 4 that receives an information processing result can be the same client terminal, or can be different client terminals. Client terminal 4 can be a standalone device, or can be a virtual module in a device, e.g., a virtual machine. A device can run a plurality of virtual machines, thus having a plurality of client terminals 4.

Neural network executing machine 6 is a system that includes a neural network composed of neural network nodes 61 and uses the neural network for information processing. It can be a single device that runs all neural network nodes 61 thereon, or can be a cluster composed of a plurality of devices, each device of which runs some of the neural network nodes 61.

Neural network training machine 10 is a machine for training the above neural network. Neural network executing machine 6 can use the neural network for information processing, but the neural network needs to be trained during initialization. Neural network training machine 10 is a machine that uses a large number of samples to train the neural network, adjusts weights of neural network nodes in the neural network, and the like. It can be a single device, or can be a cluster composed of a plurality of devices, each device of which performs a part of the training. The embodiments of the present disclosure are implemented mainly on neural network training machine 10.

As described above, existing software trimming approaches do not save the computation overhead and the memory access overhead because the gradients of the trimmed weights are still computed. The embodiments of the present disclosure are implemented by hardware. A weight signal and a trimming signal indicating whether the weight of each neural network node is used in weight gradient computation are stored in a compressed form. The trimming signal corresponding to the weight signal can be used to indicate whether each neural network node needs to be trimmed. Each bit of the trimming signal indicates whether a neural network node corresponding to a corresponding bit in the weight signal is trimmed. If the weight signal has 8 bits, the corresponding trimming signal also has 8 bits. To compute a weight gradient, a decompressing unit decompresses the trimming signal from a compressed weight signal. The trimming signal is used for controlling whether to allow an access to an operand memory storing operands used in the weight computation. The trimming signal is further used for controlling whether the computing unit is allowed to perform weight gradient computation using the weight signal and the operands. When controlling whether to allow an access to the operand memory, if the trimming signal indicates that the weight of the neural network node cannot be used, it is controlled not to allow an access to an operand memory corresponding to the neural network node; otherwise, the access is allowed, thus achieving the purpose of reducing the memory access overhead. When controlling whether the computing unit is allowed to perform weight gradient computation using the weight signal and the operands, if the trimming signal indicates that the weight of the neural network node cannot be used, the computing unit is not allowed to perform weight gradient computation using the weight signal and the operands; otherwise, the computing unit is allowed, thus achieving the purpose of reducing the computation overhead.

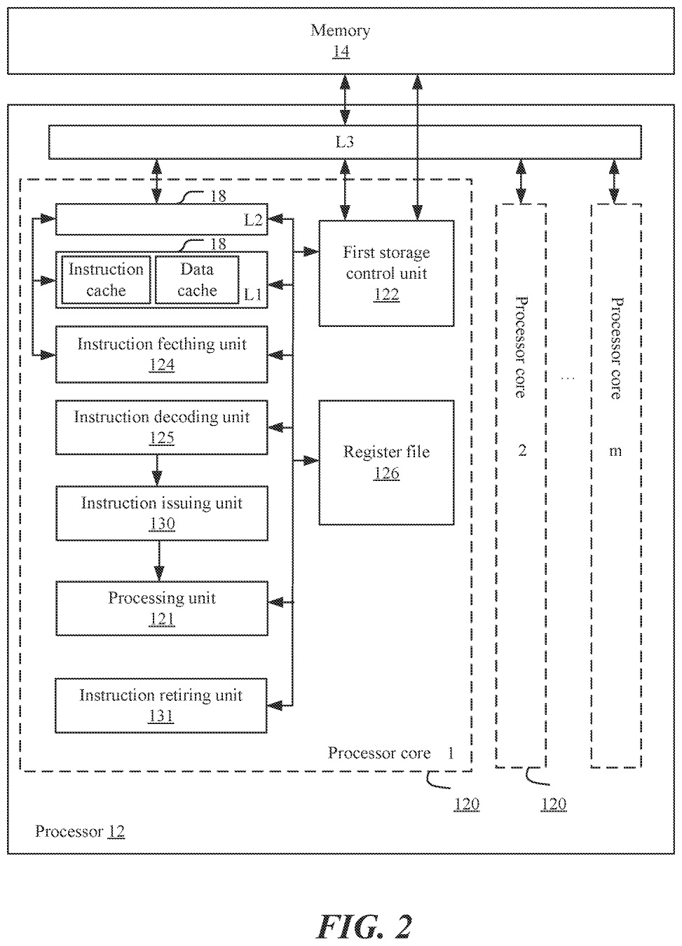

FIG. 2 is a block diagram of an exemplary neural network training machine, consistent with some embodiments of the present disclosure. Neural network training machine 10 is an example of a center system architecture. As shown in FIG. 1, neural network training machine 10 includes memory 14 and processor 12. A memory (e.g., memory 14) is a physical structure located within a computer system and configured to store information. The computer system can be a general-purpose embedded system, a desktop computer, a server, a system-on-chip, or other systems with information processing capabilities. Based on different uses, the memory can be divided into a main memory (also referred to as an internal storage, or referred to as an internal memory/main memory for short) and a secondary memory (also referred to as an external storage, or referred to as an auxiliary memory/external memory for short). The main memory is configured to store instruction information or data information indicated by data signals, e.g., is configured to store data provided by a processor, or can be configured to implement information exchange between the processor and the external memory. Only after being transferred into the main memory, can the information provided by the external memory be accessed by the processor. Therefore, the memory mentioned herein generally refers to the main memory, and the storage device mentioned herein generally refers to the external memory. The exemplary neural network training machine can include other units such as a display and input and output devices.

In some embodiments, processor 12 can include one or more processor cores 120 for processing instructions, and processing and execution of the instructions can be controlled by an administrator (e.g., through an application program) or a system platform. In some embodiments, each processor core 120 can be configured to process a specific instruction set. In some embodiments, the instruction set can support complex instruction set computing (CISC), reduced instruction set computing (RISC), or very long instruction word (VLIW)-based computing. Different processor cores 120 can each process different or identical instruction sets. In some embodiments, processor core 120 can further include other processing modules, e.g., a digital signal processor (DSP). As shown in FIG. 2, processor 12 can include processor core 1, processor core 2, . . . and processor core m. The number m is the total number of the processor cores.

In some embodiments, processor 12 has cache memory 18. Moreover, based on different architectures, cache memory 18 can be a single or multistage internal cache memory located inside or outside each processor core 101 (e.g., 3-stage cache memories L1 to L3 as shown in FIG. 2, uniformly marked as 18), and can also include an instruction-oriented instruction cache and a data-oriented data cache. In some embodiments, various components in processor 12 can share at least some of the cache memories. As shown in FIG. 2, processor cores 1 to m, for example, share third-stage cache memory L3. Processor 12 can further include an external cache (not shown). Other cache structures can also serve as external caches of processor 12.

In some embodiments, as shown in FIG. 2, processor 12 can include register file 126. Register file 126 can include a plurality of registers configured to store different types of data or instructions. These registers can be of different types. For example, register file 126 can include: an integer register, a floating-point register, a status register, an instruction register, a pointer register, and the like. The registers in the register file 126 can be implemented by using general-purpose registers, or can adopt a specific design based on actual demands of processor 12.

Processor 12 is configured to execute an instruction sequence (e.g., a program). A process of executing each instruction by processor 12 includes steps such as fetching an instruction from a memory storing instructions, decoding the fetched instruction, executing the decoded instruction, saving an instruction executing result, and so on, and these steps are repeated until all instructions in the instruction sequence are executed or a stop instruction is encountered.

Processor 12 can include instruction fetching unit 124, instruction decoding unit 125, instruction issuing unit 130, processing unit 121, and instruction retiring unit 131.

As a start engine of processor 12, instruction fetching unit 124 is configured to transfer an instruction from memory 14 to the instruction register (which can be a register configured to store instructions in register file 26 shown in FIG. 2), and receive a next instruction fetch address or compute to obtain a next instruction fetch address based on an instruction fetch algorithm. The instruction fetch algorithm, for example, includes: incrementing or decrementing the address based on an instruction length.

After fetching the instruction, processor 12 enters an instruction decoding stage, in which instruction decoding unit 125 decodes the fetched instruction in accordance with a predetermined instruction format to obtain operand acquisition information required by the fetched instruction, thereby making preparations for operations of instruction executing unit 121. The operand acquisition information, for example, points to immediate data, a register, or other software/hardware that can provide a source operand. An operand is an entity on which an operator acts, is a component of an expression, and specifies an amount of digital operations in an instruction.

Instruction issuing unit 130 is usually present in high-performance processor 12, is located between instruction decoding unit 125 and processing unit 121, and is configured to dispatch and control instructions, so as to efficiently allocate the instructions to different processing units 121. After an instruction is fetched, decoded, and dispatched to corresponding processing unit 121, corresponding processing unit 121 starts to execute the instruction, i.e., executes an operation indicated by the instruction and implements a corresponding function.

Instruction retiring unit 131 is mainly configured to write an executing result generated by processing unit 121 back to a corresponding storage location (e.g., a register inside processor 12), such that subsequent instructions can quickly acquire the corresponding executing result from the storage location.

For instructions of different types, different processing units 121 can be provided in processor 12 accordingly. Processing unit 121 can be an operation unit (e.g., including an arithmetic logic unit, a vector operation unit, etc., and configured to perform an operation based on operands and output an operation result), a memory executing unit (e.g., configured to access a memory based on an instruction to read data in the memory or write specified data into the memory, etc.), a coprocessor, or the like.

When executing instructions of a certain type (e.g., a memory access instruction), processing unit 121 needs to access memory 14 to acquire information stored in memory 14 or provide data required to be written into memory 14.

In a process of training a neural network, a neural network training algorithm can be compiled into instructions for execution. As mentioned above, in a process of training a neural network, it is often necessary to compute a weight gradient of neural network nodes. The instructions compiled based on the neural network training algorithm can contain instructions for computing the weight gradient of the neural network nodes.

First, instruction fetching unit 124 successively fetches instructions one by one from the instructions compiled based on the neural network training algorithm. The fetched instructions contain the instructions for computing the weight gradient of the neural network nodes. Then, instruction decoding unit 125 can decode these instructions one by one, and find that the instructions are the instructions for computing the weight gradient. The instructions have storage addresses storing weights and operands required for weight gradient computation (in memory 14 or in cache memory 18). In the embodiments of the present disclosure, the weights are carried in a weight signal, and the weight signal and a trimming signal are compressed into a compressed weight signal. In the neural network, each neural network node has a weight value. These weight values are often not stored separately, the weight values of a plurality of neural network nodes (e.g., 8 nodes) are combined into one signal for unified storage. Each bit of the weight signal represents a weight of a neural network node. Therefore, the storage address storing the weights is actually a storage address where the compressed weight signal is stored in memory 14 or cache memory 18. The storage address storing the operands refers to a storage address of the operands in memory 14 or cache memory 18.

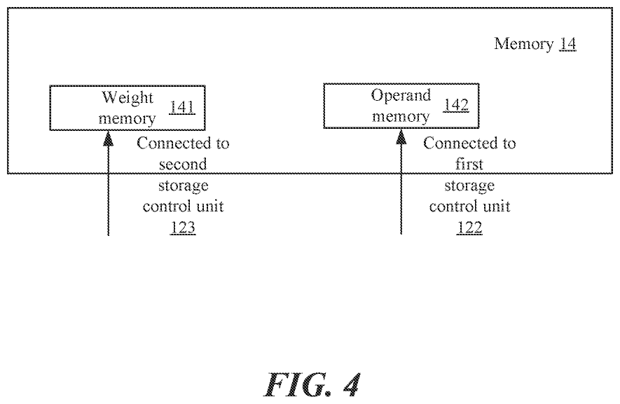

The decoded instructions for weight gradient computation with the storage address of the compressed weight signal and the storage address of the operands are provided to processing unit 121 in FIG. 2. Processing unit 121 can not necessarily compute the weight gradient for each neural network node based on the weights and the operands, but fetches the compressed weight signal based on the storage address of the compressed weight signal, and decompresses the compressed weight signal into the weight signal and the trimming signal. The trimming signal indicates which neural network nodes can be trimmed, i.e., can not be considered in weight gradient computation. Thus, processing unit 121 can, only for untrimmed neural network nodes, control to allow weight gradient computation to be performed for these neural network nodes, and control to allow an access to corresponding operand memory 142 based on the storage address of the operands, thus reducing the computation overhead of the processor and the access overhead of the memory. As shown in FIG. 4, memory 14 includes various types of memories, where operand memory 142 is a memory that stores operands other than weights required in weight gradient computation. In some embodiments, the operands can also be stored in cache memory 18.

As mentioned above, processing unit 121 controls, based on whether the neural network nodes are trimmed, whether to allow an access to the corresponding operand memory based on the storage address of the operands. This control process is implemented by first storage control unit 122. The trimming signal decompressed by processing unit 121 can be fed to first storage control unit 122. Based on which neural network nodes are trimmed as indicated by the trimming signal, first storage control unit 122 controls not to allow an access to operand memory 142 corresponding to these trimmed neural network nodes, and controls to allow an access to operand memory 142 corresponding to untrimmed neural network nodes.

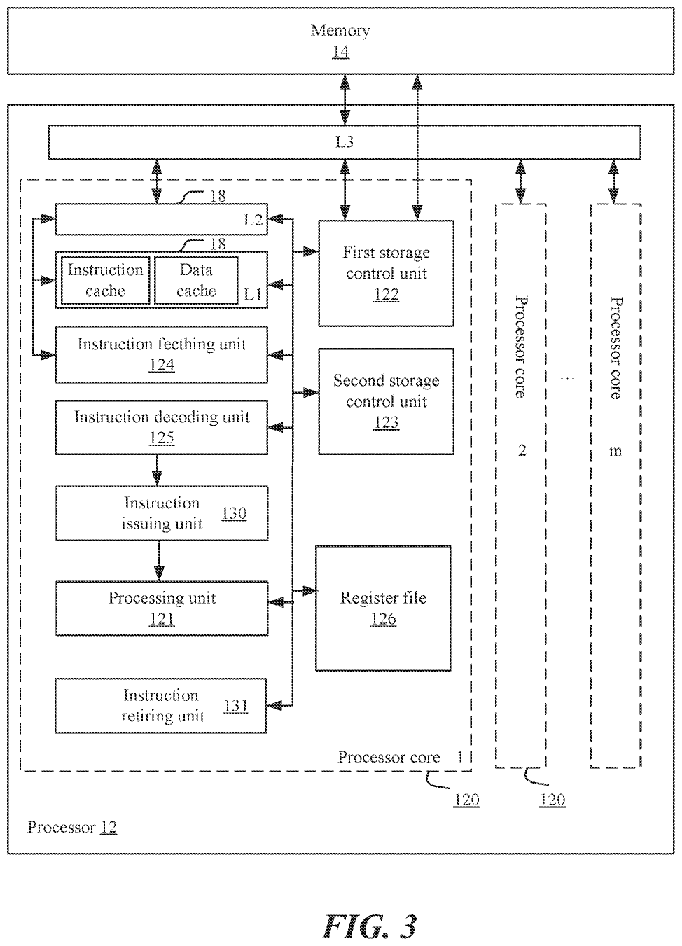

FIG. 3 is a block diagram of an exemplary neural network training machine, consistent with some embodiments of the present disclosure.

Compared with FIG. 2, neural network training 10 in FIG. 3 is additionally provided with second storage control unit 123 in processor 12. Second storage control unit 123 determines whether to allow an access to a weight memory corresponding to a corresponding neural network node based on whether each neural network node is trimmed as indicated by a trimming signal, and obtains a corresponding weight.

In some embodiments, the weight is put in a weight signal. The weight signal is stored in weight memory 141 included in memory 14 of FIG. 4. In some embodiments, the weight signal can also be stored in cache memory 18.

After an instruction is acquired by instruction fetching unit 124, instruction decoding unit 125 can decode the instruction and find that the instruction is an instruction for computing a weight gradient. The instruction has a storage address of a compressed weight signal and a storage address of operands. Processing unit 121 can fetch the compressed weight signal based on the storage address of the compressed weight signal, and decompress the compressed weight signal into a weight signal and a trimming signal. Processing unit 121 can, only for untrimmed neural network nodes, control to allow weight gradient computation to be performed for these neural network nodes, control to allow an access to corresponding operand memory 142 through first storage control unit 122 based on the storage address of the operand, and control to allow the access to corresponding weight memory 141 through second storage control unit 123 based on a pre-known weight storage address corresponding to each neural network node, thus reducing the computation overhead of the processor and the access overhead of the memory. In this case, if a neural network node is trimmed, neither a corresponding operand nor a corresponding weight is allowed to be accessed.

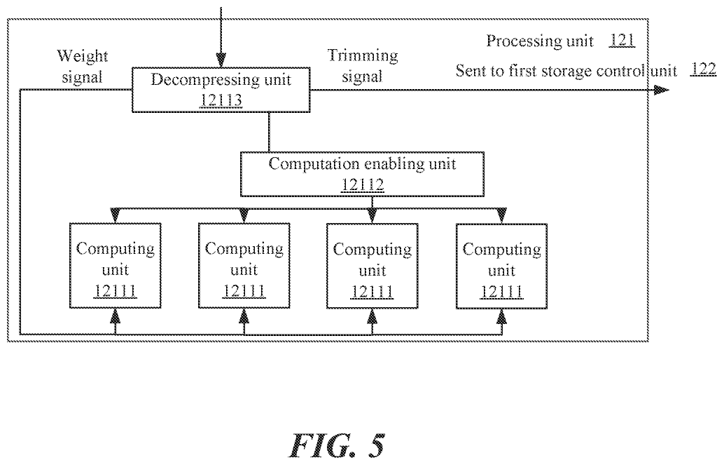

Exemplary processing units are shown in FIGS. 5-8

FIG. 5 is a schematic block diagram of an exemplary processing unit in a neural network training machine, consistent with some embodiments of the present disclosure. As shown in FIG. 5, processing unit 121 includes decompressing unit 12113, computation enabling unit 12112, and computing unit 12111.

Computing unit 12111 is a unit that performs weight gradient computation of neural network nodes. In some embodiments, there can be a plurality of computing units 12111. Each computing unit 12111 corresponds to a neural network node, and a weight gradient of the neural network node is computed based on the weight of the neural network node and other operands.

Decompressing unit 12113 is a unit that acquires a compressed weight signal and decompresses the compressed weight signal into a weight signal and a trimming signal. As mentioned above, decompressing unit 12113 acquires a decoded instruction for weight gradient computation from instruction decoding unit 125. The instruction has a storage address of the compressed weight signal and a storage address of the operands. Decompressing unit 12113 reads the compressed weight signal from a corresponding storage location in memory 14 or cache memory 18 based on the storage address of the compressed weight signal.

The compressed weight signal is a signal obtained by compressing the weight signal and the trimming signal.

The weight signal can be used to express weights of a plurality of neural network nodes. Putting only a weight of one neural network node in one weight signal can cause resource wastes. A plurality of weight bits can be included in one weight signal, and each bit expresses a weight of one neural network node. In one example, the number of bits of a weight signal can be equal to the number of neural network nodes. In this case, weight values of all neural network nodes in a neural network can be put in one weight signal. In other examples, the number of bits of a weight signal can also be less than the number of neural network nodes. In this case, the weight values of all neural network nodes in a neural network can be put in a plurality of weight signals respectively. For example, each weight signal can have 8 weight bits, which express weight values of 8 neural network nodes respectively. There are 36 neural network nodes in total, and 4 weight signals can be used to express weight values of all the neural network nodes.

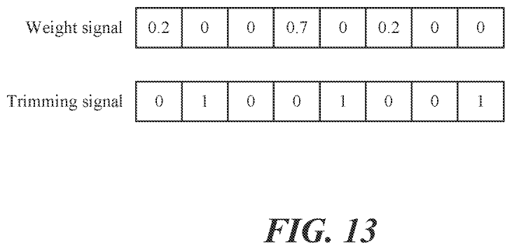

The trimming signal is a signal indicating whether a weight of each neural network node is used (e.g., whether the weight of each neural network node is not trimmed) in the weight gradient computation. The trimming signal can include a plurality of indicator bits, the number of which is identical to the number of bits of the weight signal. Each indicator bit indicates whether a neural network node of a corresponding weight bit in the weight signal is trimmed. Each indicator bit corresponds to a weight bit. For example, if the weight signal has 8 bits, the corresponding trimming signal also has 8 bits. A first bit of the trimming signal represents whether a neural network node corresponding to a first bit of the weight signal is trimmed, a second bit of the trimming signal represents whether a neural network node corresponding to a second bit of the weight signal is trimmed. Indicator bit 1 can be used to indicate that the corresponding neural network node is not trimmed, i.e., the weight of the corresponding neural network node can be used in weight gradient computation; and indicator bit 0 can be used to indicate that the corresponding neural network node is trimmed, i.e., the weight of the corresponding neural network node cannot be used in weight gradient computation. In the example shown in FIG. 13, the first bit of the trimming signal is 0, indicating that weight value 0.2 of the first bit of the weight signal is not used in weight gradient computation; the second bit of the trimming signal is 1, indicating that weight value 0 of the second bit of the weight signal is used in weight gradient computation. In a different example (not shown in FIG. 13), the values of the indicator bits can be used in an opposite manner. Indicator bit 0 can also be used for indicating that the corresponding neural network node is not trimmed, and indicator bit 1 can be used for indicating that the corresponding neural network node is trimmed. Other different values can also be used to distinguish and indicate whether a corresponding neural network node is trimmed.

The weight signal and the trimming signal can be compressed using an existing data compression method. Based on an existing data compression method, after the weight signal and the trimming signal are compressed, a compressed version of the weight signal and a digital matrix are generated. The compressed version of the weight signal contains all information of the weight signal, but occupies much less storage space (e.g., original 8 bits become 2 bits in the compressed version). The digital matrix represents information contained in the trimming signal. Thus, a total size of the compressed version of the weight signal and the digital matrix generated by compression is much smaller than a total size of the original weight signal and trim information, thus greatly reducing the space occupied by storage.

The decompression method used by decompressing unit 12113 can be an existing data decompression method. Based on an existing data decompression method, the compressed version of the weight signal and the digital matrix generated by compression are converted back into the previous weight signal and trimming signal. The weight signal is sent to each computing unit 12111, such that when computing the weight gradient using the weights and operands, corresponding computing unit 12111 acquires the weight of a neural network node corresponding to computing unit 12111 from the weight signal for weight gradient computation.

The trimming signal generated by decompression is outputted to computation enabling unit 12112 for controlling whether computing unit 12111 is allowed to perform weight gradient computation using the weight signal and the operands. In addition, the trimming signal is further outputted to first storage control unit 122 in FIG. 2 for controlling whether to allow an access to operand memory 142 storing the operands used in the weight computation. The weights are used in the weight computation. The weight computation also involves other operands, operand memory 142 stores these operands used in the weight computation.

Computation enabling unit 12112 controls, based on the trimming signal, whether computing unit 12111 is allowed to perform weight gradient computation using the weight signal and the operands. Specifically, when there is a plurality of computing units 12111 and each computing unit 12111 corresponds to a neural network node respectively. Different bits of the trimming signal indicate whether different neural network nodes are trimmed. When a bit of the trimming signal indicates that the corresponding neural network node is trimmed, corresponding computing unit 12111 is controlled not to perform weight gradient computation using the weight signal and the operands. When a bit of the trimming signal indicates that the corresponding neural network node is not trimmed, corresponding computing unit 12111 is controlled to perform weight gradient computation using the weight signal and the operands. In the example shown in FIG. 13, the first bit of the trimming signal is 0, indicating that the corresponding neural network node is trimmed, and computing unit 12111 corresponding to the neural network node is controlled not to perform weight gradient computation.

The second bit of the trimming signal is 1, indicating that the corresponding neural network node is not trimmed, and computing unit 12111 corresponding to the neural network node is controlled to perform weight gradient computation.

Computation enabling unit 12112 can control whether computing unit 12111 is allowed to perform weight gradient computation by various approaches.

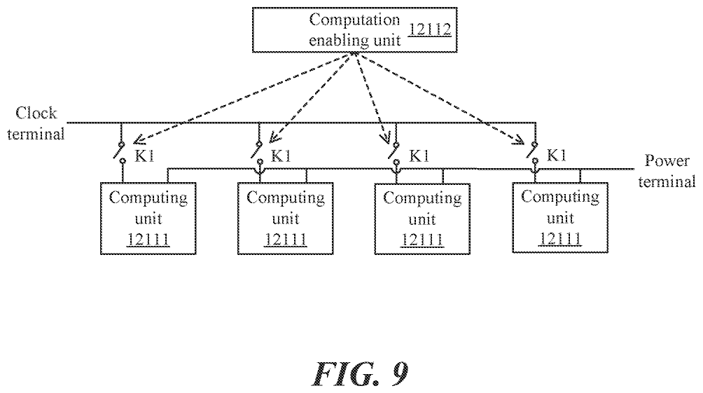

FIG. 9 is a schematic diagram of an exemplary control mode of controlling a computing unit by a computation enabling unit, consistent with some embodiments of the present disclosure. As shown in FIG. 9, the plurality of computing units 12111 are connected to a clock terminal respectively through their respective clock switches K1, and computation enabling unit 12112 determines, based on whether each neural network node is trimmed as indicated by the trimming signal, whether to connect or disconnect a clock switch connected to one computing unit 12111 corresponding to the neural network node. Specifically, if a bit of the trimming signal indicates that a corresponding neural network node should be trimmed, then the clock switch connected to computing unit 12111 corresponding to the neural network node is allowed to be disconnected. Thus, computing unit 12111 is no longer provided with a clock, and computing unit 12111 cannot work normally, thus achieving the purpose of not performing weight gradient computation of the neural network node. If a bit of the trimming signal indicates that a corresponding neural network node is not trimmed, then the clock switch connected to computing unit 12111 corresponding to the neural network node is allowed to be connected. Thus, computing unit 12111 is provided with the clock, and computing unit 12111 works normally to perform weight gradient computation of the neural network node. In the example in FIG. 13, the first bit of the trimming signal is 0, indicating that the corresponding neural network node should be trimmed, and then the clock switch connected to computing unit 12111 corresponding to the neural network node is allowed to be disconnected. Computing unit 12111 cannot work normally, and does not perform weight computation of the neural network node. The second bit of the trimming signal is 1, indicating that the corresponding neural network node is not trimmed, and then the clock switch connected to computing unit 12111 corresponding to the neural network node is allowed to be connected. Computing unit 12111 works normally and performs weight gradient computation of the neural network node.

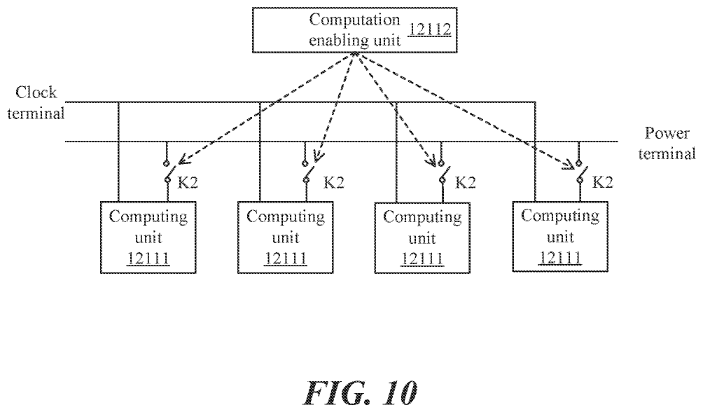

FIG. 10 is a schematic diagram of an exemplary control mode of controlling a computing unit by a computation enabling unit, consistent with some embodiments of the present disclosure. As shown in FIG. 10, the plurality of computing units 12111 are connected to a power terminal respectively through their respective power switches K2, and computation enabling unit 12112 determines, based on whether each neural network node is trimmed as indicated by the trimming signal, whether to connect or disconnect a power switch connected to computing unit 12111 corresponding to the neural network node. Specifically, if a bit of the trimming signal indicates that the corresponding neural network node should be trimmed, then the power switch connected to computing unit 12111 corresponding to the neural network node is allowed to be disconnected. Thus, computing unit 12111 is no longer provided with power, and computing unit 12111 cannot work normally, thus achieving the purpose of not performing weight gradient computation of the neural network node. If a bit of the trimming signal indicates that the corresponding neural network node is not trimmed, then the power switch connected to computing unit 12111 corresponding to the neural network node is allowed to be connected. Thus, computing unit 12111 is provided with power, and computing unit 12111 works normally to perform weight gradient computation of the neural network node. As shown in FIG. 13, the first bit of the trimming signal is 0, indicating that the corresponding neural network node should be trimmed, and then the power switch connected to computing unit 12111 corresponding to the neural network node is allowed to be disconnected. Computing unit 12111 cannot work normally, and does not perform weight gradient computation of the neural network. The second bit of the trimming signal is 1, indicating that the corresponding neural network node is not trimmed, and then the power switch connected to computing unit 12111 corresponding to the neural network node is allowed to be connected. Computing unit 12111 works normally, and performs weight gradient computation of the neural network node.

As described above, the clock switch and the power switch are used for controlling whether computing unit 12111 is allowed to perform the weight gradient computation using the weight signal and the operands. In some embodiments, controlling whether computing unit 12111 is allowed to perform the weight gradient computation can be performed without using the clock switch and the power switch. The hardware-based control mode provided by the embodiments is beneficial to reduce the occupancy of storage space and reduce the processing burden of the processor.

As described above, computation enabling unit 12112 is used to control, based on the trimming signal, whether computing unit 12111 is allowed to perform weight gradient computation using the weight signal and the operands. In some embodiments, computing unit 12111 can be controlled without using computation enabling unit 12112. For example, the trimming signal generated by compression can be sent to each computing unit 12111, and each computing unit 12111 can disconnect or connect, by itself, the clock switch or power switch connected to itself based on whether the neural network node corresponding to itself is trimmed as indicated by the trimming signal.

First storage control unit 122 controls whether to allow the access to operand memory 142 storing the operands used in the weight computation based on the trimming signal. In memory 14, there can be a plurality of operand memories 142. Each operand memory 142 corresponds to a neural network node. Since different bits of the trimming signal indicate whether different neural network nodes are trimmed, when a bit of the trimming signal indicates that the corresponding neural network node is trimmed, corresponding operand memory 142 is controlled to be inaccessible, such that the operand cannot be obtained to perform weight gradient computation. When a bit of the trimming signal indicates that the corresponding neural network node is not trimmed, corresponding operand memory 142 is controlled to be accessible, i.e., the operand can be obtained to perform weight gradient computation. In the example shown in FIG. 13, the first bit of the trimming signal is 0, indicating that the corresponding neural network node is trimmed, and operand memory 142 corresponding to the neural network node is controlled to be inaccessible, and the second bit of the trimming signal is 1, indicating that the corresponding neutral network node is not trimmed, and operand memory 142 corresponding to the neural network node is controlled to be accessible.

First storage control unit 122 can control whether to allow the access to the operand memory storing the operands used in the weight computation by various approaches described below.

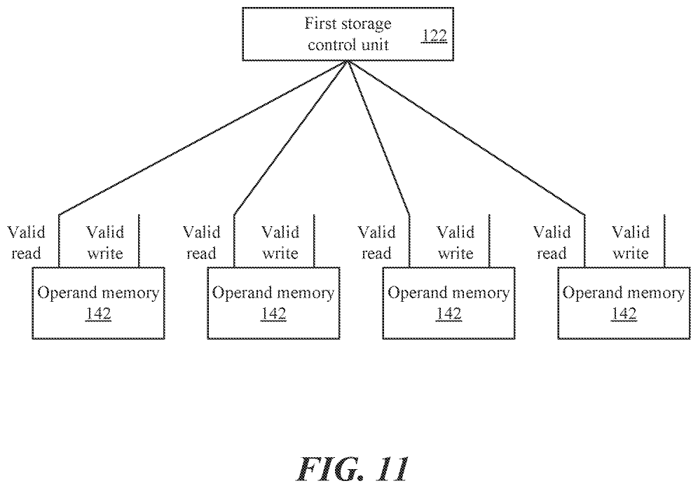

FIG. 11 is a schematic diagram of an exemplary control mode of controlling an operand memory by a first storage control unit, consistent with some embodiments of the present disclosure. As shown in FIG. 11, each of the plurality of operand memories 142 corresponds to a neural network node and has its own valid read port and valid write port. The valid read port is a control port that controls whether the operand is allowed to be read from the operand memory. For example, when a high level signal “1” is inputted into the valid read port, it means that read is valid, i.e., the operand is allowed to be read from the operand memory; and when a low level signal “0” is inputted into the valid read port, it means that read is invalid, i.e., the operand is not allowed to be read from the operand memory. It can also be set reversely. The valid write port is a control port that controls whether to allow the operand to be written into the operand memory. For example, when a high level signal “1” is inputted into the valid write port, it means that write is valid, i.e., the operand is allowed to be written into the operand memory; and when a low level signal “0” is inputted into the valid write port, it means that write is invalid, i.e., the operand is not allowed to be written into the operand memory. It can also be set reversely.

As shown in FIG. 11, first storage control unit 122 is connected to the valid read port of each operand memory. An approach to prevent the operand in the corresponding operand memory from being read for weight gradient computation when a neural network node is trimmed is shown in FIG. 11. First storage control unit 122 is not connected to a valid write port in this example. First storage control unit 122 determines, based on whether each neural network node is trimmed as indicated by the trimming signal, whether to connect the valid read port of the corresponding operand memory with a high level signal, (e.g., by setting the valid read port as “1”) or with a low level signal, (e.g., by setting the valid read port as “0.”) Specifically, if the valid read port set as “1” means that read is valid, the valid read port set as “0” means that read is invalid, and a bit of the trimming signal indicates that the corresponding neural network node should be trimmed, then the valid read port of operand memory 142 corresponding to the neural network node is allowed to be set as “0.” Operand memory 142 is inaccessible, thus reducing the storage space occupancy. If a bit of the trimming signal indicates that the corresponding neural network node should not be trimmed, then the valid read port of operand memory 142 corresponding to the neural network node is set as “1.” Operand memory 142 is accessible. In the example shown in FIG. 13, the first bit of the trimming signal is 0, indicating that the corresponding neural network node should be trimmed, and then the valid read port of operand memory 142 corresponding to the neural network node is set as “0”; and the second bit of the trimming signal is 1, indicating that the corresponding neutral network node is not trimmed, and then the valid read port of operand memory 142 corresponding to the neural network node is set as “1.”

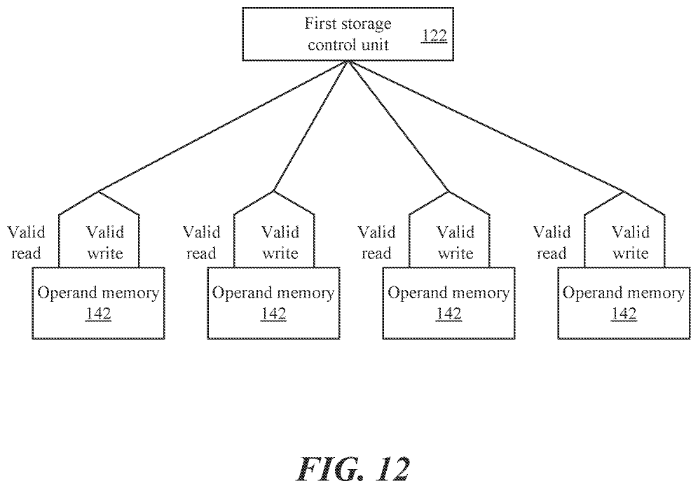

FIG. 12 is a schematic diagram of an exemplary control mode of controlling an operand memory by a first storage control unit, consistent with some embodiments of the present disclosure.

As shown in FIG. 12, first storage control unit 122 is connected to both the valid read port and the valid write port of each operand memory. Thus, if a bit of the trimming signal indicates that the corresponding neural network node should not be trimmed, then both the valid read port and the valid write port of operand memory 142 corresponding to the neural network node are set as “1.” If a bit of the trimming signal indicates that the corresponding neural network node should be trimmed, then both the valid read port and the valid write port of operand memory 142 corresponding to the neural network node are set as “0.” Although whether the valid read port is set is only concerned, setting both the valid read port and the valid write port does not affect the access to operand memory 142.

In some embodiments, controlling the access to operand memory 142 can be performed without setting the valid read port of the operand memory. The hardware-based implementation provided by the embodiments is beneficial to reduce the occupancy of storage space and reduce the processing burden of the processor.

In some embodiments, controlling whether to allow an access to operand memory 142 based on the trimming signal can be performed without using first storage control unit 122. For example, the trimming signal can be decompressed by decompressing unit 12113 to control whether to allow the access to operand memory 142.

As shown in FIG. 5, the weight signal decompressed by decompressing unit 12113 is directly sent to each computing unit 12111. Its advantage is that the circuit structure is relatively simple. It is compatible with the structure of processor 12 in FIG. 2. Even if a neural network node is to be trimmed based on the trimming signal, corresponding computing unit 12111 does not work, and operand memory 142 where the operand required to compute the weight gradient is located is also prohibited from being accessed, but the weight signal can still be sent to each computing unit.

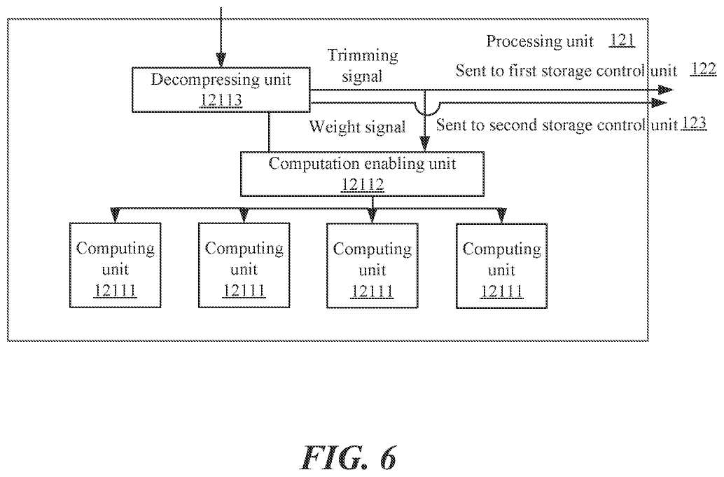

As shown in FIG. 6, corresponding to the structure of processor 12 in FIG. 3, second storage control unit 123 coupled to decompressing unit 12113 is additionally provided. The coupling can be a direct connection or a connection through other components. The weight signal decompressed by decompressing unit 12113 is not directly sent to each computing unit 12111 but outputted to weight memory 141 coupled to decompressing unit 12113 via second storage control unit 123 (as shown in FIG. 4). After the decompressed weight signal is transmitted to weight memory 141 for storage, it is not read out at any time. Whether to allow the access to weight memory 141 is to be controlled by second storage control unit 123. In some embodiments, similar to the operand memory, the weight memory also has a valid read port and a valid write port. Functions of the valid read port and the valid write port are similar to those of the operand memory. The second storage control unit is connected to the valid read port of each weight memory, or is connected to both the valid read port and the valid write port of each weight memory. Decompressing unit 12113 sends the decompressed trimming signal to second storage control unit 123. Second storage control unit 123 controls whether to set the valid read port of weight memory 141 based on the trimming signal outputted by decompressing unit 12113.

There can be a plurality of weight memories 141. Each weight memory 141 corresponds to a neural network node respectively. Since different bits of the trimming signal indicate whether different neural network nodes are trimmed, when a bit of the trimming signal indicates that the corresponding neural network node is trimmed, second storage control unit 123 sets weight memory 141 storing the weight signal of the neural network node as “0,” i.e., connects it with a low level signal, such that computing unit 12111 cannot obtain the weight to perform weight gradient computation. When a bit of the trimming signal indicates that the corresponding neural network node is not trimmed, second storage control unit 123 sets weight memory 141 storing the weight signal of the neural network node as “1,” i.e., connects it with a high level signal, such that computing unit 12111 can obtain the weight to perform weight gradient computation. In the example shown in FIG. 13, the first bit of the trimming signal is 0, indicating that the corresponding neural network node is trimmed, and weight memory 141 corresponding to the neural network node is set as “0”; and the second bit of the trimming signal is 1, indicating that the corresponding neutral network node is not trimmed, and weight memory 141 corresponding to the neural network node is set as “1.”

The weight signal is not directly outputted to each computing unit 12111 but stored in weight memory 141. Based on whether the corresponding neural network node is trimmed as indicated by the bit in the trimming signal, whether the weight signal stored in weight memory 141 is to be read is determined, thereby acquiring the corresponding weight for weight gradient computation, reducing the transmission burden, and improving the data security.

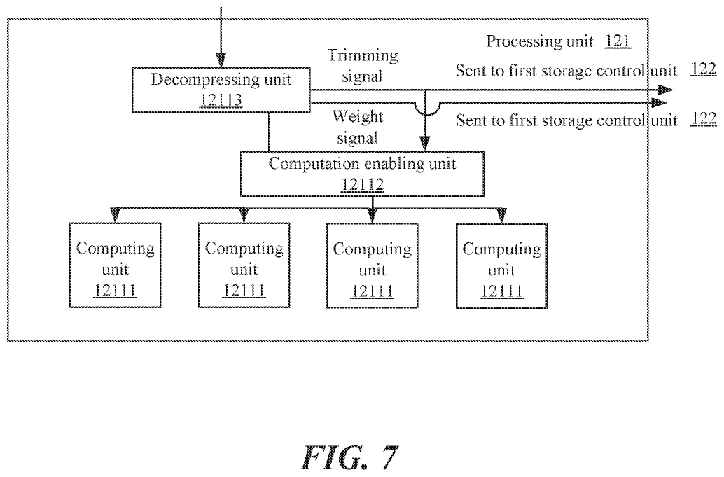

Second storage control unit 123 is not provided in the exemplary processing unit as shown in FIG. 7, which is different from the exemplary processing unit in FIG. 6. Whether to allow the access to weight memory 141 is still controlled by first storage control unit 122. Decompressing unit 12113 sends the decompressed trimming signal to first storage control unit 123. Based on the trimming signal, first storage control unit 122 not only controls whether to allow the access to operand memory 142 storing the operands used in the weight computation, but also controls whether to allow the access to weight memory 141 storing the weight used in the weight computation.

Since different bits of the trimming signal indicate whether different neural network nodes are trimmed, when a bit of the trimming signal indicates that the corresponding neural network node is trimmed, corresponding operand memory 142 is controlled to be inaccessible, and corresponding weight memory 141 is controlled to be inaccessible, such that neither the operand nor the weight can be obtained to perform weight gradient computation; and when a bit of the trimming signal indicates that the corresponding neural network node is not trimmed, corresponding operand memory 142 is controlled to be accessible, and corresponding weight memory 141 is controlled to be accessible, such that weight gradient computation can be performed based on the operand and the weight. In the example shown in FIG. 13, the first bit of the trimming signal is 0, indicating that the corresponding neural network node is trimmed, and operand memory 142 and weight memory 141 corresponding to the neural network node are controlled to be inaccessible; and the second bit of the trimming signal is 1, indicating that the corresponding neutral network node is not trimmed, and operand memory 142 and weight memory 141 corresponding to the neural network node are controlled to be accessible. Second storage control unit 123 is omitted, thereby simplifying the structure.

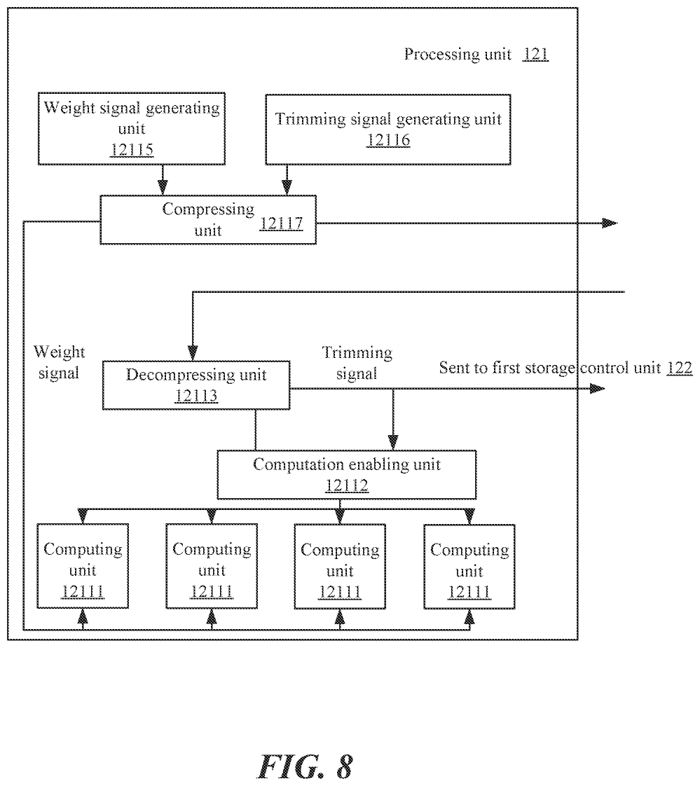

How the compressed weight signal is generated is not concerned, and only a process is only considered, in which the compressed weight signal is used to decompress the trimming signal therefrom for controlling which neural network node-related computing units 12111 can be only allowed to work, and which neural network node-related operand memories 142 and weight memories 141 are only allowed to be accessed. As shown in FIG. 8, a process of generating the compressed weight signal is also considered.

As shown in FIG. 9, weight gradient computation instruction executing unit 1211 is additionally provided with weight signal generating unit 12115, trimming signal generating unit 12116, and compressing unit 12117 on the basis of FIG. 6.

Weight signal generating unit 12115 generates a weight signal based on a weight of each neural network node. In neural network training, the weight of each neural network node is iteratively determined. An initial weight of the neural network node is preset, and then the neural network node is trained based on samples. Output of initial samples are inputted from the samples, whether the output meets expectation is monitored, the weight of the neural network node is adjusted accordingly, and then samples are re-inputted for the next round of adjustment. Here, the weight based on which the weight signal is generated is a weight of the last round of neural network node. In this round, processing unit 121 computes a weight gradient in accordance with the method of embodiments of the present disclosure, while other instruction executing units can compute a new weight in this round accordingly, and determine which neural network nodes are to be trimmed in the next round to achieve iterative training. Generating the weight signal from the weight can be implemented by putting weights of a plurality of neural network nodes in different weight bits of the weight signal. For example, in FIG. 13, the weight signal includes 8 weight bits. Weight values 0.2, 0, 0, 0.7, 0, 0.2, 0, and 0 of 8 neural network nodes are put in 8 weight bits respectively to get the weight signal.

Trimming signal generating unit 12116 generates the trimming signal based on an indication on whether the weight of each neural network node is used in weight gradient computation. In some embodiments, the indication can be inputted by an administrator. For example, the administrator observes the role played by each neural network node in determining the weight gradient in the last round of iterative training, and inputs an indication on whether the neural network node is to be trimmed in the next round through an operation interface. In some other embodiments, the indication is determined by other instruction executing unit in the last round of iteration based on the weight gradient of each node computed in the last round. Trimming signal generating unit 12116 acquires the indication from the other instruction executing unit.

In some embodiments, the trimming signal can be generated based on the indication on whether the weight of each neural network node is used in weight gradient computation by the following approach: for each indicator bit of the trimming signal, if a weight of a neural network node corresponding to the indicator bit can be used in weight gradient computation, then it is set as a first value; and if the weight of the neural network node corresponding to the indicator bit cannot be used in weight gradient computation, then it is set as a second value. As shown in FIG. 13, for a first indicator bit of the trimming signal, the indication indicates that a weight of a neural network node corresponding to the indicator bit is not used in weight gradient computation, and then it is set as 0; and for a second indicator bit of the trimming signal, the indication indicates that the weight of the neural network node corresponding to the indicator bit is used in weight gradient computation, and then it is set as 1; and so on.

Compressing unit 12117 compresses the generated weight signal and the generated trimming signal into the compressed weight signal. The compression approach can be that: a compressed version of the weight signal and a digital matrix are generated based on the weight signal and the trimming signal. The compressed version of the weight signal and the digital matrix serve as the compressed weight signal, where the compressed version of the weight signal contains all information of the weight signal, but occupies less storage space than the weight signal, and the digital matrix represents information contained in the trimming signal. An existing compression method can be used for compression.

After the compressed weight signal is generated by compressing unit 12111, it can then be sent to a compressed weight signal memory (not shown) for storage. When necessary, compressed weight signal acquiring unit 12114 acquires the compressed weight signal from the compressed weight signal memory.

After the present disclosure is applied to a data center, energy consumption of the data center can be theoretically reduced by at most 80%, thus saving the energy expenditure by 60%. In addition, this technology can increase the number of trainable neural network models by 2-3 times, and increase the neural network update speed by 2-3 times. The market value of related neural network training products using this technology can be improved by 50%.

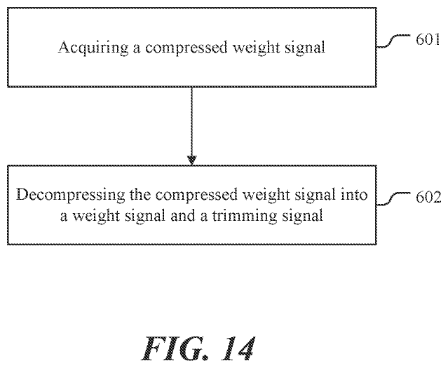

FIG. 14 is a flowchart of an exemplary processing method, consistent with some embodiments of the present disclosure. The processing method is for weight gradient computation and can include the following steps.

In step 601, a compressed weight signal is acquired, the compressed weight signal being obtained by compressing a weight signal and a trimming signal, and the trimming signal indicating whether a weight of each neural network node is used in weight gradient computation.

In step 602, the compressed weight signal is decompressed into the weight signal and the trimming signal, the trimming signal being used for controlling whether to allow an access to an operand memory storing operands used in the weight computation, and the trimming signal being further used for controlling whether a computing unit is allowed to perform weight gradient computation using the weight signal and the operands.

In the embodiments of the present disclosure, the weight signal and the trimming signal indicating whether the weight of each neural network node is used in weight gradient computation (i.e., whether the neural network node is trimmed) are stored in a compressed form. When it is necessary to compute a weight gradient, the trimming signal is decompressed from the compressed weight signal. The trimming signal is used for controlling whether to allow the access to the operand memory storing the operands used in the weight computation, and is used for controlling whether the computing unit is allowed to perform weight gradient computation using the weight signal and the operands. When controlling whether to allow an access to the operand memory, if the trimming signal indicates that the weight of the neural network node cannot be used, it is controlled not to allow the access to the operand memory corresponding to the neural network node; otherwise, the access is allowed. Thus, if the weight cannot be used, there is no corresponding access overhead, thus achieving the purpose of reducing the memory access overhead. When controlling whether the computing unit is allowed to perform weight gradient computation using the weight signal and the operands, if the trimming signal indicates that the weight of the neural network node cannot be used, the computing unit is not allowed to perform weight gradient computation using the weight signal and the operands, thereby reducing the computation overhead of the processor when determining the weight gradient of the neural network.

The present application further discloses a computer-readable storage medium including computer-executable instructions stored thereon. The computer-executable instructions, when executed by a processor, cause the processor to execute the above-described methods according to the embodiments herein.

It is appreciated that the above descriptions are only exemplary embodiments provided in the present disclosure. Consistent with the present disclosure, those of ordinary skill in the art may incorporate variations and modifications in actual implementation, without departing from the principles of the present disclosure. Such variations and modifications shall all fall within the protection scope of the present disclosure.

It is appreciated that terms “first,” “second,” and so on used in the specification, claims, and the drawings of the present disclosure are used to distinguish similar objects. These terms do not necessarily describe a particular order or sequence. The objects described using these terms can be interchanged in appropriate circumstances. That is, the procedures described in the exemplary embodiments of the present disclosure could be implemented in an order other than those shown or described herein. In addition, terms such as “comprise,” “include,” and “have” as well as their variations are intended to cover non-exclusive inclusion. For example, a process, method, system, product, or device including a series of steps or units are not necessarily limited to the steps or units clearly listed. In some embodiments, they may include other steps or units that are not clearly listed or inherent to the process, method, product, or device.

As used herein, unless specifically stated otherwise, the term “or” encompasses all possible combinations, except where infeasible. For example, if it is stated that a device may include A or B, then, unless specifically stated otherwise or infeasible, the device may include A, or B, or A and B. As a second example, if it is stated that a device may include A, B, or C, then, unless specifically stated otherwise or infeasible, the device may include A, or B, or C, or A and B, or A and C, or B and C, or A and B and C. The disclosed embodiments may further be described using the following clauses:
1. A processing unit, comprising:
a computing unit having circuitry configured to perform a weight gradient computation of neural network nodes; and
a decompressing unit having circuitry configured to decompress an acquired compressed weight signal into a weight signal and a trimming signal, wherein the weight signal comprises a weight of each neural network node, the trimming signal indicates whether the weight of each neural network node is used in the weight gradient computation, the trimming signal is used for controlling an access to an operand memory storing operands used in the weight computation of one or more neural network nodes corresponding to the operand memory, and the trimming signal is further used for controlling the computing unit to perform the weight gradient computation using the weight signal and the operands for the one or more neural network nodes.
2. The processing unit according to clause 1, wherein
the weight signal comprises a plurality of weight bits, each of the weight bits comprising a weight of a neural network node; and
the trimming signal comprises a plurality of indicator bits, each indicator bit corresponding to one weight bit, each indicator bit indicating whether a weight in the corresponding weight bit is used in the weight gradient computation, a total number of the indicator bits of the weight signal is identical to a total number of the weight bits of the weight signal, wherein the indicator bit comprises a first value and a second value, the first value indicates that a weight of a neural network node in a weight bit corresponding to the first value is used in the weight gradient computation, and the second value indicates that a weight of a neural network node in a weight bit corresponding to the second value is not used in the weight gradient computation.
3. The processing unit according to clause 1 or 2, further comprising:
a computation enabling unit coupled to the decompressing unit and having circuitry configured to receive the trimming signal outputted from the decompressing unit, and having circuitry configured to control, based on the trimming signal, the computing unit to perform the weight gradient computation using the weight signal and the operands.
4. The processing unit according to clause 3, wherein the computing unit is a
plurality of computing units, each of the computing units corresponds to a neural network node, the plurality of computing units are connected to a clock terminal respectively through their respective clock switches, and
the computation enabling unit includes circuitry configured to control each clock switch of the plurality of computing units based on the trimming signal.
5. The processing unit according to clause 3, wherein the computing unit is a plurality of computing units, each of the computing units corresponds to a neural network node, each of computing units is connected to a power terminal through a corresponding power switch, and
the computation enabling unit includes circuitry configured to control each power switch of the plurality of computing units based on the trimming signal.
6. The processing unit according to clause 1 or 2, wherein
the decompressing unit is coupled to a first storage control unit external to the processing unit, and
the first storage control unit includes circuitry configured to control, based on the trimming signal, the access to the operand memory storing the operands used in the weight computation.
7. The processing unit according to clause 6, wherein the operand memory is a plurality of operand memories, each operand memory corresponds to a neural network node, each operand memory has a valid read port, and
the first storage control unit is coupled to the valid read port of each operand memory and includes circuitry configured to set the valid read port of each operand memory based on the trimming signal.
8. The processing unit according to clause 1 or 2, wherein the decompressing unit is coupled to the computing unit and includes circuitry configured to output the decompressed weight signal to the computing unit for the weight gradient computation.
9. The processing unit according to clause 1 or 2, wherein the decompressing unit is coupled to a plurality of weight memories and includes circuitry configured to output the decompressed weight signal to the plurality of weight memories, each weight memory corresponds to a neural network node, and each weight memory has a valid read port; and the decompressing unit is further coupled to a second storage control unit external to the processing unit, and the second storage control unit is coupled to the valid read port of each weight memory and includes circuitry configured to set the valid read port of each weight memory based on the trimming signal.
10. The processing unit according to clause 7, wherein the decompressing unit is coupled to a plurality of weight memories and includes circuitry configured to output the decompressed weight signal to the plurality of weight memories, each weight memory corresponds to a neural network node, and each weight memory has a valid read port; and the decompressing unit is further coupled to the first storage control unit, and the first storage control unit is further coupled to the valid read port of each weight memory and includes circuitry configured to set the valid read port of each weight memory based on the trimming signal.
11. The processing unit according to clause 1 or 2, further comprising:
a weight signal generating unit having circuitry configured to generate the weight signal based on the weight of each neural network node;
a trimming signal generating unit having circuitry configured to generate the trimming signal based on an indication on whether the weight of each neural network node is used in the weight gradient computation; and
a compressing unit having circuitry configured to compress the generated weight signal and the generated trimming signal into the compressed weight signal.
12. A processor core, comprising:
a processing unit, comprising: a computing unit having circuitry configured to perform a weight gradient computation of neural network nodes; and
a decompressing unit having circuitry configured to decompress an acquired compressed weight signal into a weight signal and a trimming signal, wherein the weight signal comprises a weight of each neural network node, the trimming signal indicates whether the weight of each neural network node is used in the weight gradient computation, the trimming signal is used for controlling an access to an operand memory storing operands used in the weight computation of one or more neural network nodes corresponding to the operand memory, and the trimming signal is further used for controlling the computing unit to perform the weight gradient computation using the weight signal and the operands for the one or more neural network nodes.
13. A neural network training machine, comprising:
a memory coupled to a storing unit, the memory at least comprising an operand memory; and
a processing unit comprising:
a computing unit having circuitry configured to perform a weight gradient computation of neural network nodes; and
a decompressing unit having circuitry configured to decompress an acquired compressed weight signal into a weight signal and a trimming signal, wherein the weight signal comprises a weight of each neural network node, the trimming signal indicates whether the weight of each neural network node is used in the weight gradient computation, the trimming signal is used for controlling an access to an operand memory storing operands used in the weight computation of one or more neural network nodes corresponding to the operand memory, and the trimming signal is further used for controlling the computing unit to perform the weight gradient computation using the weight signal and the operands for the one or more neural network nodes.
14. A processing method for weight gradient computation, comprising:
acquiring a compressed weight signal; and
decompressing the compressed weight signal into a weight signal and a trimming signal, wherein the weight signal comprises a weight of each neural network node, the trimming signal indicates whether the weight of each neural network node is used in a weight gradient computation, the trimming signal is used for controlling an access to an operand memory storing operands used in the weight computation of one or more neural network nodes corresponding to the operand memory, and the trimming signal is further used for controlling a computing unit to perform weight gradient computation using the weight signal and the operands for the one or more neural network nodes.
15. The processing method for weight gradient computation according to clause 14, wherein
the weight signal comprises a plurality of weight bits, each of the weight bits comprises a weight of a neural network node; and
the trimming signal comprises a plurality of indicator bits, each indicator bit corresponding to one weight bit, each indicator bit indicating whether a weight in the corresponding weight bit is used in the weight gradient computation, a total number of the indicator bits of the weight signal is identical to a total number of the weight bits of the weight signal, wherein the indicator bit comprises a first value and a second value, the first value indicates that a weight of a neural network node in a weight bit corresponding to the first value is used in the weight gradient computation, and the second value indicates that a weight of a neural network node in a weight bit corresponding to the second value is not used in the weight gradient computation.
16. The processing method for weight gradient computation according to clause 14 or 15, wherein the computing unit comprises a plurality of computing units, each of the computing units corresponds to a neural network node, each of the computing units is connected to a clock terminal through a corresponding clock switch, and
controlling the computing unit to perform the weight gradient computation using the weight signal and the operands comprises:
controlling each clock switch of the plurality of computing units based on the trimming signal.
17. The processing method for weight gradient computation according to clause 14 or 15, wherein the computing unit comprises a plurality of computing units, each of the computing units corresponds to a neural network node, each of the computing units is connected to a power terminal through a corresponding power switch, and
controlling the computing unit to perform the weight gradient computation using the weight signal and the operands comprises:
controlling each power switch of the plurality of computing units based on the trimming signal.
18. The processing method for weight gradient computation according to clause 14 or 15, wherein the operand memory comprises a plurality of operand memories, each operand memory corresponds to a neural network node, each operand memory comprises a valid read port, a storage control unit is coupled to the valid read port of each operand memory, and
controlling the access to the operand memory storing the operands used in the weight computation comprises:
setting the valid read port of each operand memory based on the trimming signal.
19. The processing method for weight gradient computation according to clause 14 or 15, wherein after decompressing the compressed weight signal into the weight signal and the trimming signal, the method further comprises:
performing the weight gradient computation based on the trimming signal using the decompressed weight signal and the operands obtained by accessing the operand memory.
20. The method for executing a weight gradient computation instruction according to clause 14 or 15, wherein the trimming signal is further used for controlling whether to allow an access to a weight memory storing the weight of each neural network node, and
after decompressing the compressed weight signal into the weight signal and the trimming signal, the method further comprises:
performing the weight gradient computation based on the trimming signal using the weights obtained by accessing the weight memory and the operands obtained by accessing the operand memory.
21. The method for executing a weight gradient computation instruction according to clause 14 or 15, wherein before acquiring the compressed weight signal, the method further comprises:
generating the weight signal based on the weight of each neural network node;
generating the trimming signal based on an indication on whether the weight of each neural network node is used in weight gradient computation; and
compressing the generated weight signal and the generated trimming signal into the compressed weight signal.

Based on the several embodiments provided in the present disclosure, it should be appreciated that the disclosed technical contents may be implemented in another manner. The described apparatus, system, and method embodiments are only exemplary. For example, division of units or modules are merely exemplary division based on the logical functions. Division in another manner may exist in actual implementation. Further, a plurality of units or components may be combined or integrated into another system. Some features or components may be omitted or modified in some embodiments. In addition, the mutual coupling or direct coupling or communication connections displayed or discussed may be implemented by using some interfaces. The indirect coupling or communication connections between the units or modules may be implemented electrically or in another form.

Further, the units described as separate parts may or may not be physically separate. Parts displayed as units may or may not be physical units. They may be located in a same location or may be distributed on a plurality of network units. Some or all of the units may be selected according to actual needs to achieve the objectives of the solutions of the embodiments. In addition, functional units in the embodiments of the present disclosure may be integrated into one processing unit. Each of the units may exist alone physically, or two or more units can be integrated into one unit. The integrated unit may be implemented in a form of hardware or may be implemented in a form of a software functional unit.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A processing unit, comprising:
a computing unit having circuitry configured to perform a weight gradient computation of neural network nodes; and
a decompressing unit having circuitry configured to decompress an acquired compressed weight signal into a weight signal and a trimming signal, wherein the weight signal comprises a weight of each neural network node, the trimming signal indicates whether the weight of each neural network node is used in the weight gradient computation, the trimming signal is used for controlling an access to an operand memory storing operands used in the weight computation of one or more neural network nodes corresponding to the operand memory, and the trimming signal is further used for controlling the computing unit to perform the weight gradient computation using the weight signal and the operands for the one or more neural network nodes.

2. The processing unit according to claim 1, wherein
the weight signal comprises a plurality of weight bits, each of the weight bits comprising a weight of a neural network node; and
the trimming signal comprises a plurality of indicator bits, each indicator bit corresponding to one weight bit, each indicator bit indicating whether a weight in the corresponding weight bit is used in the weight gradient computation, a total number of the indicator bits of the weight signal is identical to a total number of the weight bits of the weight signal, wherein the indicator bit comprises a first value and a second value, the first value indicates that a weight of a neural network node in a weight bit corresponding to the first value is used in the weight gradient computation, and the second value indicates that a weight of a neural network node in a weight bit corresponding to the second value is not used in the weight gradient computation.

3. The processing unit according to claim 1, further comprising:
a computation enabling unit coupled to the decompressing unit and having circuitry configured to receive the trimming signal outputted from the decompressing unit, and having circuitry configured to control, based on the trimming signal, the computing unit to perform the weight gradient computation using the weight signal and the operands.

4. The processing unit according to claim 3, wherein the computing unit is a plurality of computing units, each of the computing units corresponds to a neural network node, the plurality of computing units are connected to a clock terminal respectively through their respective clock switches, and
the computation enabling unit includes circuitry configured to control each clock switch of the plurality of computing units based on the trimming signal.

5. The processing unit according to claim 3, wherein the computing unit is a plurality of computing units, each of the computing units corresponds to a neural network node, each of computing units is connected to a power terminal through a corresponding power switch, and
the computation enabling unit includes circuitry configured to control each power switch of the plurality of computing units based on the trimming signal.

6. The processing unit according to claim 1, wherein
the decompressing unit is coupled to a first storage control unit external to the processing unit, and
the first storage control unit includes circuitry configured to control, based on the trimming signal, the access to the operand memory storing the operands used in the weight computation.

7. The processing unit according to claim 6, wherein the operand memory is a plurality of operand memories, each operand memory corresponds to a neural network node, each operand memory has a valid read port, and
the first storage control unit is coupled to the valid read port of each operand memory and includes circuitry configured to set the valid read port of each operand memory based on the trimming signal.

8. The processing unit according to claim 1, wherein the decompressing unit is coupled to the computing unit and includes circuitry configured to output the decompressed weight signal to the computing unit for the weight gradient computation.

9. The processing unit according to claim 1, wherein the decompressing unit is coupled to a plurality of weight memories and includes circuitry configured to output the decompressed weight signal to the plurality of weight memories, each weight memory corresponds to a neural network node, and each weight memory has a valid read port; and the decompressing unit is further coupled to a second storage control unit external to the processing unit, and the second storage control unit is coupled to the valid read port of each weight memory and includes circuitry configured to set the valid read port of each weight memory based on the trimming signal.

10. The processing unit according to claim 7, wherein the decompressing unit is coupled to a plurality of weight memories and includes circuitry configured to output the decompressed weight signal to the plurality of weight memories, each weight memory corresponds to a neural network node, and each weight memory has a valid read port; and the decompressing unit is further coupled to the first storage control unit, and the first storage control unit is further coupled to the valid read port of each weight memory and includes circuitry configured to set the valid read port of each weight memory based on the trimming signal.

11. The processing unit according to claim 1, further comprising:
a weight signal generating unit having circuitry configured to generate the weight signal based on the weight of each neural network node;
a trimming signal generating unit having circuitry configured to generate the trimming signal based on an indication on whether the weight of each neural network node is used in the weight gradient computation; and
a compressing unit having circuitry configured to compress the generated weight signal and the generated trimming signal into the compressed weight signal.

12. A processor core, comprising:
a processing unit, comprising: a computing unit having circuitry configured to perform a weight gradient computation of neural network nodes; and
a decompressing unit having circuitry configured to decompress an acquired compressed weight signal into a weight signal and a trimming signal, wherein the weight signal comprises a weight of each neural network node, the trimming signal indicates whether the weight of each neural network node is used in the weight gradient computation, the trimming signal is used for controlling an access to an operand memory storing operands used in the weight computation of one or more neural network nodes corresponding to the operand memory, and the trimming signal is further used for controlling the computing unit to perform the weight gradient computation using the weight signal and the operands for the one or more neural network nodes.

13. A neural network training machine, comprising:
a memory coupled to a storing unit, the memory at least comprising an operand memory; and
a processing unit comprising:
a computing unit having circuitry configured to perform a weight gradient computation of neural network nodes; and
a decompressing unit having circuitry configured to decompress an acquired compressed weight signal into a weight signal and a trimming signal, wherein the weight signal comprises a weight of each neural network node, the trimming signal indicates whether the weight of each neural network node is used in the weight gradient computation, the trimming signal is used for controlling an access to an operand memory storing operands used in the weight computation of one or more neural network nodes corresponding to the operand memory, and the trimming signal is further used for controlling the computing unit to perform the weight gradient computation using the weight signal and the operands for the one or more neural network nodes.

14. A processing method for weight gradient computation, comprising:
acquiring a compressed weight signal; and
decompressing the compressed weight signal into a weight signal and a trimming signal, wherein the weight signal comprises a weight of each neural network node, the trimming signal indicates whether the weight of each neural network node is used in a weight gradient computation, the trimming signal is used for controlling an access to an operand memory storing operands used in the weight computation of one or more neural network nodes corresponding to the operand memory, and the trimming signal is further used for controlling a computing unit to perform weight gradient computation using the weight signal and the operands for the one or more neural network nodes.

15. The processing method for weight gradient computation according to claim 14, wherein
the weight signal comprises a plurality of weight bits, each of the weight bits comprises a weight of a neural network node; and
the trimming signal comprises a plurality of indicator bits, each indicator bit corresponding to one weight bit, each indicator bit indicating whether a weight in the corresponding weight bit is used in the weight gradient computation, a total number of the indicator bits of the weight signal is identical to a total number of the weight bits of the weight signal, wherein the indicator bit comprises a first value and a second value, the first value indicates that a weight of a neural network node in a weight bit corresponding to the first value is used in the weight gradient computation, and the second value indicates that a weight of a neural network node in a weight bit corresponding to the second value is not used in the weight gradient computation.

16. The processing method for weight gradient computation according to claim 14, wherein the computing unit comprises a plurality of computing units, each of the computing units corresponds to a neural network node, each of the computing units is connected to a clock terminal through a corresponding clock switch, and
controlling the computing unit to perform the weight gradient computation using the weight signal and the operands comprises:
controlling each clock switch of the plurality of computing units based on the trimming signal.

17. The processing method for weight gradient computation according to claim 14, wherein the computing unit comprises a plurality of computing units, each of the computing units corresponds to a neural network node, each of the computing units is connected to a power terminal through a corresponding power switch, and
controlling the computing unit to perform the weight gradient computation using the weight signal and the operands comprises:
controlling each power switch of the plurality of computing units based on the trimming signal.

18. The processing method for weight gradient computation according to claim 14, wherein the operand memory comprises a plurality of operand memories, each operand memory corresponds to a neural network node, each operand memory comprises a valid read port, a storage control unit is coupled to the valid read port of each operand memory, and
controlling the access to the operand memory storing the operands used in the weight computation comprises:
setting the valid read port of each operand memory based on the trimming signal.

19. The processing method for weight gradient computation according to claim 14, wherein after decompressing the compressed weight signal into the weight signal and the trimming signal, the method further comprises:
performing the weight gradient computation based on the trimming signal using the decompressed weight signal and the operands obtained by accessing the operand memory.

20. The method for executing a weight gradient computation instruction according to claim 14, wherein the trimming signal is further used for controlling whether to allow an access to a weight memory storing the weight of each neural network node, and
after decompressing the compressed weight signal into the weight signal and the trimming signal, the method further comprises:
performing the weight gradient computation based on the trimming signal using the weights obtained by accessing the weight memory and the operands obtained by accessing the operand memory.

21. The method for executing a weight gradient computation instruction according to claim 14, wherein before acquiring the compressed weight signal, the method further comprises:
generating the weight signal based on the weight of each neural network node;
generating the trimming signal based on an indication on whether the weight of each neural network node is used in weight gradient computation; and
compressing the generated weight signal and the generated trimming signal into the compressed weight signal.
